(19) United States
(12) Patent Application Publication
(10) Pub. No.: US 2013/0036984 A1
(43) Pub. Date: Feb. 14, 2013

(54) Compartmentalized aquatic system

(71) Applicants: Frank Kuhn, Bedford, MA (US); Kevin McCurley, Plaistow, NH (US)

(72) Inventors: Frank Kuhn, Bedford, MA (US); Kevin McCurley, Plaistow, NH (US)

(21) Appl. No.: 13/507,777

(22) Filed: Jul. 27, 2012

Related U.S. Application Data
(60) Provisional application No. 61/574,064, filed on Jul. 27, 2011.

(51) Int. Cl. A01K 63/00; A01K 63/04

(52) U.S. Cl. 119/248

(57) ABSTRACT

An aquarium or aquatic system such as a fish tank for the safe and clean containment of a plurality of aquatic specimens such as fish, segregated from one another by a series of divider panels aligned within that tank. The divider panels are spaced from the walls and floor of that tank so as to permit a “bottom current” flow of water under those divider panels to sweep away the debris accumulating in each of those chambers, and then into a collection unit such as a series of filters, filtration system or water processors which thus treats and cleans the water and preferably reintroduces that water back into the upstream end of that water flow.

### BACKGROUND OF THE INVENTION

1. Field of the invention

This invention relates to aquatic animal culturing, including culturing of fish, crustaceans, plants, corals, and other aquatics, and aquariums and more particularly to a system for compartmentalizing such systems while permitting a flow of water between those compartments and to maintain the separation of any aquatic specimens within those compartments while also providing a superior aquatic environment, such as for display aesthetics, water quality within the compartments and the aquatic life clean and safe, while permitting aquatic waste removal and waste processing/collection. This application is based upon our U.S. Provisional Application No. 61/574,064, filed on 27 Jul. 2011, which is incorporated herein by reference in its entirety.

2. Background of the Invention

Typical aquariums will often have a variety of aquatic specimens within a typically elongated tank. Those aquatic specimens may get along with each other and they may not. Those elongated tanks often have to be cleaned out relatively frequently because of the contamination from the specimens and whatever else may collect within the water. Many types of aquatic specimens do not get along well with one another and will attack and/or eat their tank mates if and when they are given the chance.

It is an object of the present invention to provide an aquarium which may be subdivided into varying sized compartments to segregate any particular aquatic specimens or species of specimens from any other specimens.

It is a further object of the present invention to provide an aquarium which is intended to have an extended life cycle without requiring the need for frequent cleansing of the tanks or their individual compartments.

It is a still further object of the present invention to provide an aquarium for multiple specimens, one or more of whom require cleaner water than the other specimens or the downstream currents of the other specimens to allow and promote the exchange of chemical stimulants between the specimens.

It is a further object of the present invention to provide a “bottom current” or a similar means to sweep sedimentary debris from successive compartments and into a filtration and processing/collection system to provide a cleaner and more healthy environment, while permitting the further use of such aquatic/fish debris.

It is yet a further object of the present invention to provide a “low current” living and display environment for aquatic specimens that prefer such conditions within a portion of the compartment, and also provide “cleansing currents” that infiltrate filtered water into each respective compartment and remove waste and debris from such compartment and process it in the filtration part of the aquatic system.

It is another object of the present invention to provide a means to contain large specimens within respective compartments while allowing smaller aquatic specimens passage to one or more of the other compartments and by the graduation in size of respective compartment dividers creating a method to sort the specimens by size, thereby minimizing interaction and chances for predation between larger and smaller specimens including parent and offspring.

It is a further object of the present invention to provide an aquarium for multiple aquatic specimens, one or more of whom require cleaner water, or other condition and state, including in the introduction and transfer of nutrients or chemicals and stimulants from other specimens and anthropogenic means than the others.

It is another object of the present invention to provide compartments which permit the individual respective use of each as filtration systems including the use of flora and aquatic specimens to provide additional filtration capacity, prior to a subsequent compartments, with an anesthetic display.

It is yet a further object of the present invention to create a filtration system in the rear portion of the elongated tank that processes waste water and thereby cleansing, treating and aerating the water in the aquatic system and also being the means for creating the flow and current of the system. This filtration system draws in the water from the last compartment at one end of the elongated tank and ejects the cleansed and treated water into a first compartment at the other end of the process or the elongated tank. A variant of this system could draw water from a center section or compartment and use one or more respective end sections or compartments for discharging cleansed or treated water individually or in combination.

### BRIEF SUMMARY OF THE INVENTION

The present invention comprises an aquatic system for the compartmentalized storage/display and maintenance of a plurality of aquatic specimens, such as for example fish or other live aquatic specimens. The aquatic system in a first preferred embodiment thereof comprises an elongated tank having a first or upstream end wall and a second or downstream end wall, a bottom or floor, and a front wall and a rear wall. The elongated tank in this particular embodiment is divided into a plurality of compartments by a plurality of spaced apart divider panels. This embodiment may include a filtration system attached to the rear of the tank, comprised of a new rear tank wall, sidewalls, a bottom and various divider panels utilized in the filtration/treatment process with this filtration system also being the means to establish the flow or current in the main compartmentalized aquatic storage section of the elongated tank.

The divider panels are supported transversely across the longitudinal length of the tank by engagement tabs discussed hereinbelow. Each divider panel has an elongated gap between its lowermost edge and the bottom or floor of the tank. Each divider panel also has an elongated gap between its respective side edges and the adjacent sidewalls of the tank. The divider panels may be spaced apart a uniform distance or a non-uniform distance from one another, as necessary, for the segregated containment of different sizes of different aquatic species within their own individual compartment(s).

The divider panels themselves may be transparent, opaque, or partially or fully opaque, or even colored, as desired. Each divider panel may also have perforations therein, to further allow transfer between compartments and permit downstream fluid flow between successively adjacent compartments. The perforations in any particular panel as well as the gaps along their side edges and the side walls and the gap between the lower edge of the divider panels and the bottom or floor of the tank would be of course smaller than any particular species of aquatic life which was being retained within that particular compartment, in order to maintain their separation from one another. Such perforations and/or gap between the lower edges of the divider panels and the floor may be, for example, about ⅛ to ½ of an inch depending upon the size and species of aquatic life contained there within. Commercially sized aquatic systems for the farming of fish and/or other species of aquatic life may necessitate larger or smaller gaps to prevent their intermixing. The gaps will allow the separation of specimens and or provide specific flow patterns within one or more individual compartment.

The purpose of the openings and/or bottom gaps is to permit a directionally aimed or a laminar flow of water to pass between the bottom of adjacent compartments and thus carry waste products such as fecal matter and aquatic debris from an upstream end of the flow of water to a downstream end of the flow of water. The aquatic life in each compartment contributes to the debris and fecal matter which settles gently to the bottom of each compartment and is swept downstream through the bottom and other gaps.

The flow of water for this aquatic system begins at the upstream end of the tank and passes through each individual compartment via the gaps and openings. The flow of water through the compartments ends at the downstream end. In this embodiment, it enters a filtration system through a plurality of holes/slots and the water exits the filtration system and back into the compartmentalized portion of the tank through one or more holes or slots in the upstream end of the tank. The filtration system itself, may contain various compartments that process the water and waste and provide treatment through mechanical, biological, chemical and or photonics. These various processing compartments can include sedimentation traps, sponges, bio media, drip tubes, mechanical pumps and aerators, agitators, protein skimmers, ultraviolet sterilizers and other filtration specific devices that aid in the process and treatment of the water in the aquatic system.

A further embodiment of the present invention comprises the bottom or floor of the aquatic system having a stepped configuration as viewed from the side. In such a stepped embodiment, the downstream divider panels would be of increasingly varying dimension to accommodate the difference in height due to the stepped bottom their adjacent. A gap or opening would still be necessary between the lower edge of each divider panel and its adjacent floor portion of its respective compartment, to accommodate and permit a smooth flow of water and the step passage of aquatic debris and fecal matter downstream.

In yet a further embodiment of the present invention, the bottom or floor of the tank is of sloped configuration as viewed from the side. In such a sloped-floor embodiment, the downstream divider panels are of increasingly greater height to accommodate the greater depth of that particular compartment. The gap or opening arrangement would still be required between the bottom edge of the divider panel and the surface of the floor there adjacent.

The aquatic system in yet a further embodiment thereof may be comprised of a non-linear tank, as for example, one of circular configuration as may be viewed in a plan view thereof. Such a non-linear tank may have an outer wall and a correspondingly configured innermost wall with the innermost wall attached to the inside of the outermost wall by a rigid panel therebetween. Such a rigid panel would function as both the beginning or upstream end of the water flow on one side thereof and as the end or downstream portion of the water flow on the other side of that rigid panel. Each respective side of that rigid panel would have a filtered water source or a filtered water extractor arranged respectively thereat. The divider panels in such a non-linear tank would divide the volume of that tank into generally “pie” shaped compartments. Each divider panel would of course have a gap or openings between its side edges and the inner wall and the inside edge of the outer wall as well as the lower edge of that panel and the floor or bottom of the tank.

A further aspect of the present invention is the method of maintaining similar or different aquatic specimens or fish and sequentially altered water within the elongated or the non-linear tank. The water in each successive chamber downstream may contain elements from the previous chambers due to the nature of the flow and the water may thus be slightly altered from its upstream neighbor. Upstream treatments, both natural and anthropogenic can alter the water to affect specific responses, such as is considered in aquaculture. The nature of the flow allows the upstream compartments to have “cleaner” water than each successive compartment.

A still further aspect of the present invention comprises the use of a retrofit panel support arrangement for use within an existing tank or core, as a kit, to enable the support of one or more divider panels therewithin, so is to subdivide a tank by those panels, while maintaining a changeable space (compartment) between those panels and the flow of water along the floor of the tank under and around the side of the tank's walls.

The invention thus comprises a system for the sustained support and segregation of various species of aquatic life in a fluid containment tank and may include a combined filtration system that also generates the current in the tank. The tank has an upstream end and a downstream end, the system comprising: an arrangement of a top cover and enclosure walls and a lowermost floor; at least one divider panel supported between the exterior walls or by means of support members to divide the tank into at least two compartments, the divider panel having a pair of side edge portion and a lowermost edge portion; a gap between the lowermost edge portion of the at least one divider panel and the lowermost floor to permit a flow of water therebetween from the upstream end and the downstream end of the containment tank, while maintaining aquatic life within the at least two compartments segregated from one another. The fluid containment tank is of rectilinear configuration in one embodiment, and non-rectilinear configuration i.e.: circular, oval or crescent shape, in other embodiments. The outer enclosure and support walls of the fluid containment tank are thus of curvilinear configuration in another preferred embodiment. The lowermost floor is of stepped configuration in one embodiment. The lowermost floor is of sloped configuration in a further embodiment. The system may include a filtration system which also generates the current in the tank, fed by water at the downstream end of the containment tank for filtering water and injecting it at the upstream end of the tank. The system may include other types of external filter arrangements utilizing both the downstream end and the upstream end of the containment tank. The system may include a fluid recycling arrangement for recycling water from the downstream end of the containment tank into the upstream end of the containment tank. The divider panels may have a gap extending between their side edges and the outer support and enclosure walls, to permit a narrow flow of water to flow from an upstream compartment to a downstream compartment along the sidewalls of the enclosure and support walls. The divider panels may be of varying or of increasing height-wise dimensions along the downstream direction for the stepped floor.

The invention also comprises a method of safely maintaining various species of aquatic life in a common containment tank, for the sustained support and segregation of various species of aquatic life in that fluid containment tank, the tank having an upstream water feed end and a downstream water discharge end, comprising: arranging an arrangement of a top cover, enclosure walls and a lowermost floor comprising the fluid containment tank; placing at least one divider panel supported between the exterior walls or by means of support members to divide the tank into at least two compartments, the divider panel having a pair of side edges and a lowermost edge in supported contact with the outer support and enclosure walls; forming a gap between the lowermost edge of the at least one divider panel and the lowermost floor to permit a flow of water therebetween from the upstream end and the downstream end of the containment tank, while maintaining aquatic life within the at least two compartments segregated from one another. The method may include filtering the water as the water is removed from the downstream end of the containment tank. The method may include recycling the water as the water is removed from the downstream end of the containment tank up to the upstream end of the containment tank. The method may include collecting the water at the downstream end and filtering the water before it is fed into the upstream end of the containment tank.

The invention also comprises a system of safely maintaining, supporting and segregating various species of aquatic life in a common aquatic containment tank, the aquatic tank having an upstream water feed end and a downstream water discharge end, the system comprising: at least one divider panel having side portions and a lower portion, the divider panel arranged across the containment tank to divide the tank into at least two species-segregatable compartments; a pump facilitated filtration arrangement to withdraw water from a downstream end of the system and to recycle the water into the upstream end of the system, the pump facilitated filtration arrangement also creating a flow of current between the at least two compartments; and at least one opening along the lower portion of the at least one divider panel to facilitate the flow of current and any movement of debris from an upstream compartment to a downstream compartment for subsequent filtration and or collection. The filtration system may be arranged at both the upstream water feed end and at the downstream water discharge end of the containment tank. The at least one divider panel is preferably displacably adjustable within the containment tank. The at least one divider panel preferably has an opening along a side edge portion thereof. The aquatic containment tank has a shape preferably selected from the group comprised of: a rectilinear configuration, a curved configuration in a plan view, and a curved configuration in a cross-sectional view.

Still another variant could draw water from the bottom/floor at one or more location in one or more compartments through slots/holes in the floor or another type of conduit resting on the floor or below for removing water to recreate or reinforce the cleansing currents and establish a bottom current flow.

### BRIEF DESCRIPTION OF THE DRAWINGS

The objects and advantages of the present invention will become more apparent, when viewed in conjunction with the following drawings in which:

FIG. 1 is a perspective view of the aquatic tank invention in its most basic format, showing the outer walls of the tank and a plurality of divider panels forming a reality of individual compartments within that tank;

FIG. 2 is a plan view of the aquatic tank shown in FIG. 1 with the divider panels herein, shown spaced unequally along its longitudinal length;

FIG. 3 is side elevation view of the aquatic tank shown in FIG. 1 where the divider panels shown spaced equally apart along its longitudinal length;

FIGS. 4A and 4B are sectional views taken along the lines 4A/4B in FIG. 3 showing the divider panels supported within the side walls and bottom of a tank of the present invention, maintaining their gap between the side walls and the bottom whilst there between while still maintaining a support within those walls to define the various compartments of it within;

FIG. 5 is a side elevational view of an elongated aquatic tank having a bottom with a stepped configuration and with divider panels of increasing height wise dimension in the downstream direction;

FIG. 6 is a side elevational view of an elongated aquatic tank having a bottom with a sloped configuration and with divider panels of increasing height wise dimension in the downstream direction;

FIG. 7 is a plan view of an aquatic tank having a non-linear configuration, in this figure the outer wall is a circular configuration dividing the compartments into pie shaped units with a common wall which marks the beginning of flow on one side and the end of flow on the other side thereof;

FIG. 8 is an elevational view of the rear side of the elongated tank represented in FIG. 2, showing a filtration arrangement at both ends thereof for filtering fluid as it exits the tank and again filtering the fluid as it enters the tank;

FIG. 9 is a plan view of the aquatic tank shown with a filter system arranged on the rear side thereof;

FIG. 10 is a cross-sectional view of a further embodiment of the aquatic tank, shown in generally crescent shape; and

FIG. 11 is a plan view of yet a further embodiment of the aquatic tank utilizing bottom/floor water discharge/collection systems, shown in an elongated tank configuration.

### DETAILED DESCRIPTION OF THE PREFERRED EMBODIMENTS

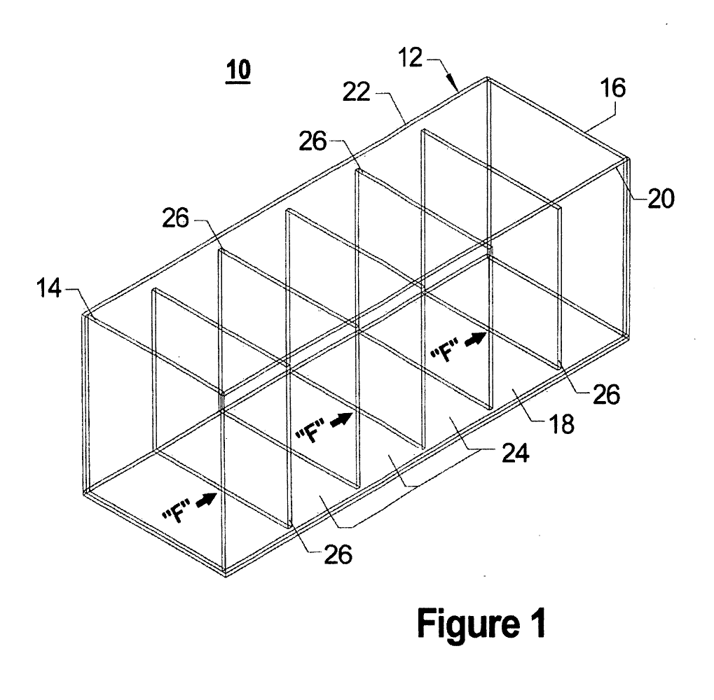

Referring now to the drawings in detail and particularly to FIG. 1, there is shown the present invention which comprises an aquatic system 10 for the compartmentalized maintenance of a plurality of aquatic specimens, such as for example numerous species of fish or the like. The aquatic system 10 in a first preferred embodiment thereof comprises an elongated tank 12 having a first or upstream end wall 14 and a second or downstream end wall 16, a bottom or floor 18, and a front wall 20 and a rear wall 22, as may be seen in FIGS. 1, 2 and 3.

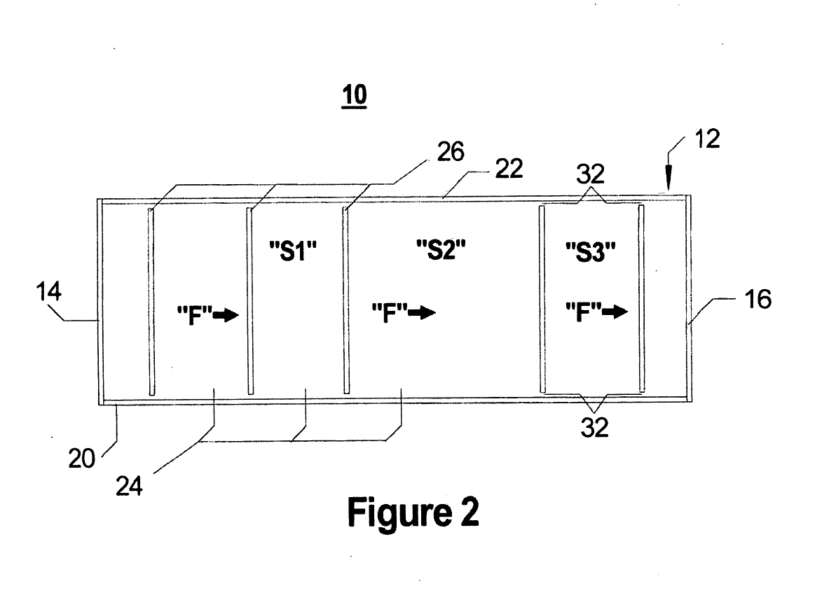

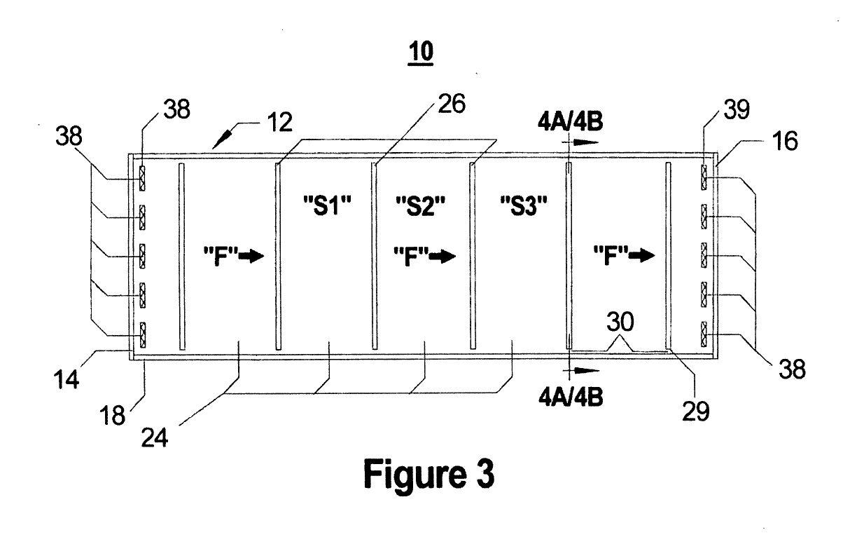

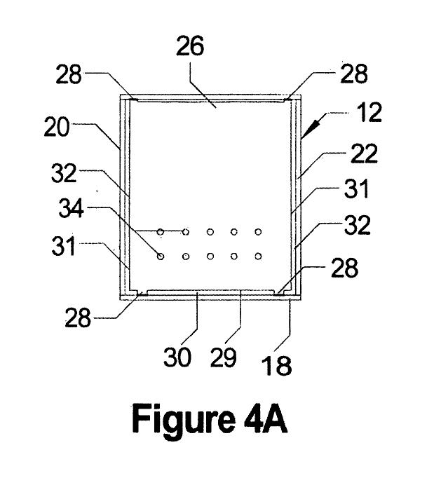

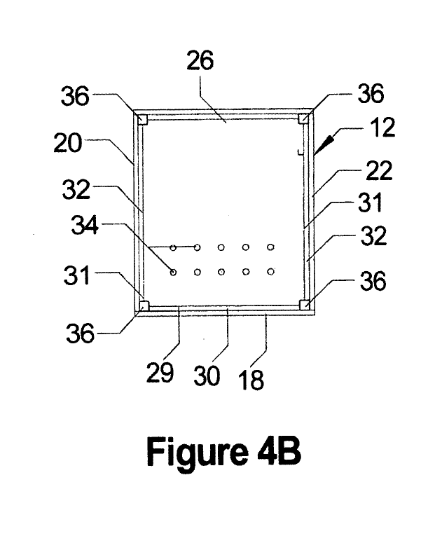

The elongated tank 12 in this particular embodiment is divided into a plurality of compartments 24 by a plurality of spaced apart divider panels 26. The divider panels 24 are supported transversely across the longitudinal length of the tank 12 by engagement tabs 28 as may be seen in FIG. 4A. Each divider panel 26 preferably has an opening or elongated gap 30 between its lowermost edge 29 in the bottom or floor 18 of the tank 12 as may be seen best in FIG. 3. Each divider panel 26 also has an opening or elongated gap 32 between its respective side edges 31 and the adjacent inner sidewalls 20 and 22 of the tank 12, as may be seen in FIG. 4A. The divider panels 26 may be spaced apart a uniform distance as shown in FIG. 3, or a non-uniform distance from one another, as shown in FIG. 2, as necessary, for the segregated containment of aquatic species “S1, S2 . . . ” within their own individual compartments 24.

The divider panels 26 themselves may be transparent, or partially or fully opaque, or even colored, as desired. Each divider panel may also have openings or perforations 34 therein as shown in FIG. 4A, to further permit fluid flow between successively adjacent compartments 24. The perforations 34 in any particular panel 26 as well as the gaps 32 along their side edges 31 and the side walls and the gap 30 between the lower edge 29 of the divider panels 26 and the bottom or floor 18 of the tank 12 would be of course smaller than any particular species of aquatic life “S” which was being retained within that particular compartment, in order to maintain their separation from one another. Such perforations 34 and/or gap 30 between the lower edges 29 of the divider panels 26 and the floor 18 may, be for example, about ⅛ to ½ of an inch depending upon the size and species of aquatic life contained there within. Commercially sized aquatic systems for the farming of fish and/or other species of aquatic life may necessitate larger or smaller gaps. The perforations 34 and gap 30 can also be sized to create unique water flow patterns in one or more specific compartment as may be preferred by a particular species for maintenance and cultivation.

The purpose of the gaps 30 and 32 is to preferably permit a laminar flow of water to pass between adjacent compartments 24 and thus carry waste, such as fecal matter, food products, detritus and aquatic debris from an upstream end of the flow of water to a downstream end of the flow of water along the floor or bottom 18 of the tank 12.

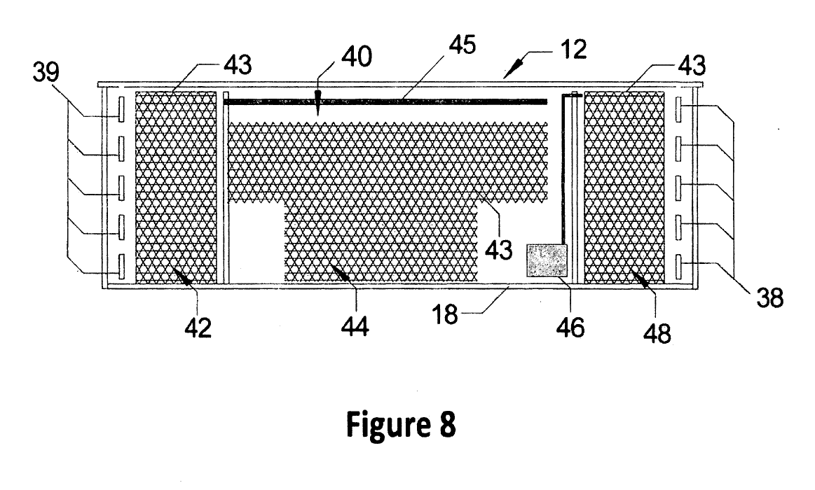

The flow of water “F” for this aquatic system 10 begins at the upstream end of the tank 12, as for example, to the right as shown in FIG. 3, through a plurality of slots 38 from a filtration system, such as 40 in FIG. 8, into each compartment 24 through the gaps 30 and 32 and/or perforations 34 to the opposite/downstream end of the tank 12 where it passes into the first compartment of the filtration system 40 through slots 39 or another means of discharge. The aquatic life in each compartment 24 contribute to the debris and fecal matter which settles gently to the bottom of each compartment 24 and is swept downstream through the gap 30 to the lower edge of each divider panel 26 and the floor or bottom 18 of the tank 12. In one embodiment of the present invention, the debris and fecal matter seized by the filtration system may be collected for further use in agriculture or the like.

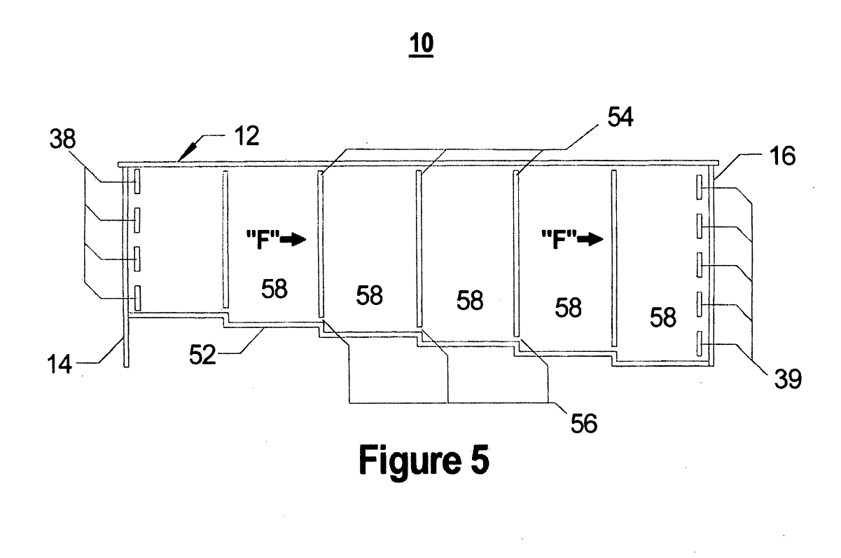

A further embodiment of the present invention comprises the bottom or floor 52 of the aquatic system having a stepped configuration as viewed from the side, as may be seen in FIG. 5. In such a stepped embodiment, the sequential downstream divider panels 54 would be increasingly of varying (taller) dimension to accommodate the difference in height due to the stepped bottom there adjacent, as may also be seen in FIG. 5. The gap 56 would still be necessary between the lower edge of each divider panel 54 and its adjacent floor portion 52 of its respective compartment 58, to accommodate and permit a smooth flow of water and the step passage of aquatic debris and fecal matter downstream.

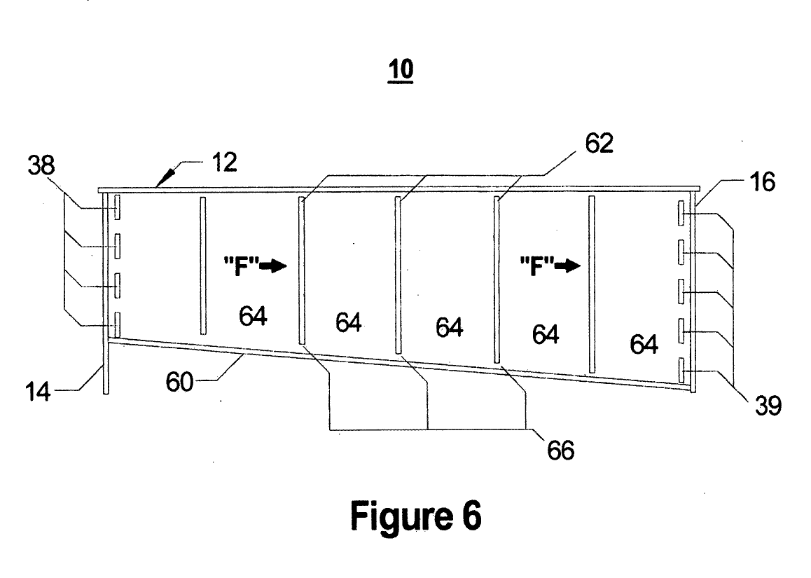

In yet a further embodiment of the present invention, as represented in FIG. 6, the bottom or floor 60 of the tank 12, is of sloped configuration as viewed from the side. In such a sloped embodiment, the downstream divider panels 62 are of increasingly greater height to accommodate the greater depth of that particular compartment 64. The gap 66 would still be required between the bottom edge of the respective divider panels 62 and the surface of the floor 60 there adjacent.

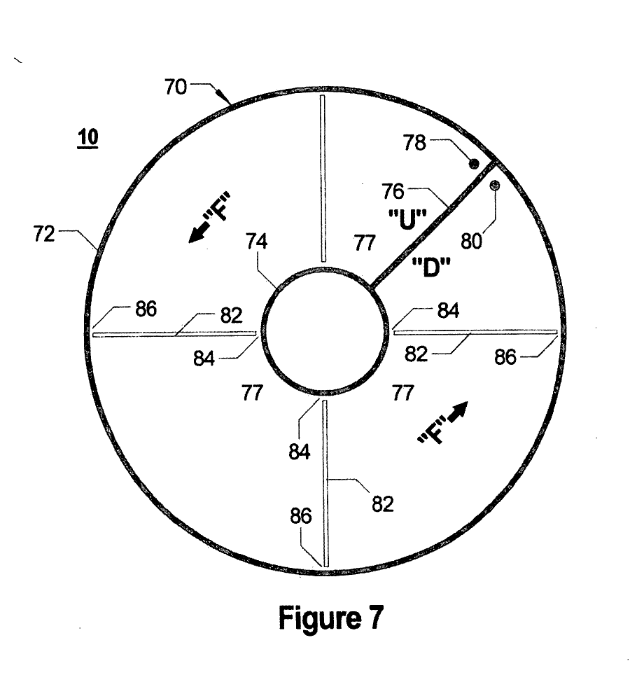

The aquatic system in yet a further embodiment thereof may be comprised of a non-linear tank 70, which for example, one of circular configuration in a plan view thereof, as represented in FIG. 7. Such a nonlinear tank 70 will have an outer wall 72 and a correspondingly configured innermost wall 74. The innermost wall 74 is preferably attached to the inside of the outermost wall 72 by a rigid wall panel 76 therebetween that prevents water flow. Such a rigid panel 76 would function as both the beginning or upstream end “U” of the water flow on one side thereof and as the end or downstream portion “D” of the water flow on the other side of that rigid panel 76. Each respective side of that rigid panel 76 would have a filtered water source 78 or a used water extractor 80 arranged respectively thereat. The divider panels 82 in such a nonlinear tank 70 would divide the volume of that tank into “pie” shaped compartments 77, as may be seen in FIG. 7. Each divider panel 82 would of course have a gap 84 between its side edges and the inner wall and a gap 86 at the inside edge of the outer wall as well as the lower edge of that panel and the floor or bottom of the tank 70, as is represented in FIG. 7.

A still yet further embodiment has a filtration system 40, as shown in FIG. 8 that withdraws compartment tank water at one end 39 of the elongated tank and discharges filtered water at the opposite end 38 thereby creating the current and the means, both filtration and other natural and anthropogenic means, to thus treat cleanse by filteration the main compartment tank. The filtration system 40 is attached to the rear of the aquatic tank 12 by any water tight means provides processing/treatment of the water and establishes the current “F” cleanses the aquatic compartments 24. In this embodiment, the water enters the filtration system through the plurality of slots 39 that withdraws compartment 24 tank water at one end of the elongated tank 12 into the first filter compartment 42, shown in FIG. 8 containing slots 39 and a filter/bio media, and passing the water through the filter media into a drip tube 45 that drips water into the second filter compartment 44 over additional filter/bio media 43 where it is then pumped 46 into the third filter compartment 48 and flowing through additional treatment means. Proposed variants of this embodiment, not shown in the figures include additional natural and anthropogenic filtration/treatment means such as natural media like gravel, rock, charcoal, wood and plant material and manmade treatment media like photonic sterilizers, chemical treatment systems, protein skimmers, aerators and other electronic and mechanical devices/means.

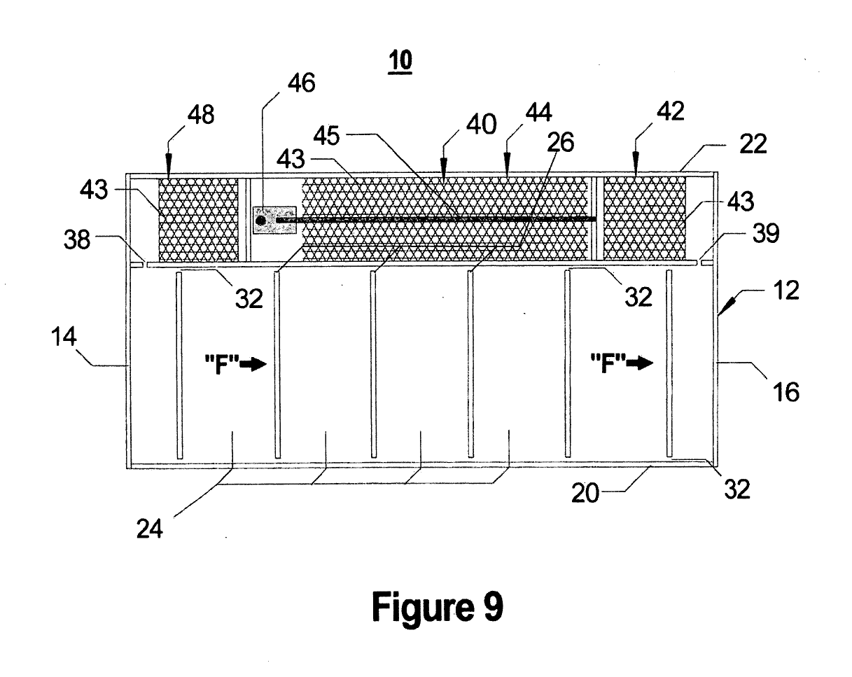

FIG. 9 shows the aquatic tank 12 with an attached filter system 40 arranged on the rear side thereof, with additional filter system compartments 42, 44, and 48 created with an additional rear wall, side walls, bottom floor panel and two rigid/wall divider panels. The filtration system withdraws the compartment tank water through the slots 39 and discharges filtered water at the opposite end through the slots 38 thereby creating a current “F” to cleanse the aquatic tank. This embodiment of the filter system illustrated in FIG. 9 shows three filter compartments, 42, 44 and 48 attached to the compartmentalized tank system 12 that is the front of the aquatic system. The water flow “F” within that tank system 10 creates the cleansing current that is an embodiment of this invention.

A further aspect of the present invention is the method of maintaining similar or different aquatic specimens or fish in sequentially altered water from the downstream currents within the longitudinal tank 12 or the non-linear tank 70 by using other specimens in preceding compartments or by introducing substances to allow and promote exchange of chemicals or stimulants between the specimens as a process in culturing, nursing or maintenance of the downstream specimens.

A still further aspect of the present invention comprises the use of a retrofit arrangement for use within an existing tank, as a kit, comprised of notched elongated supports 36 to enable the support of one or more divider panels 26 therewithin, as represented in FIG. 4B, so is to subdivide a tank 12 or 70, by those panels 26 or 76, while maintaining a changeable compartments 24 or 77 between those panels 26 or 76, and the flow of water along the floor of the tank 12 or 70 under and around the side of the tank's walls.

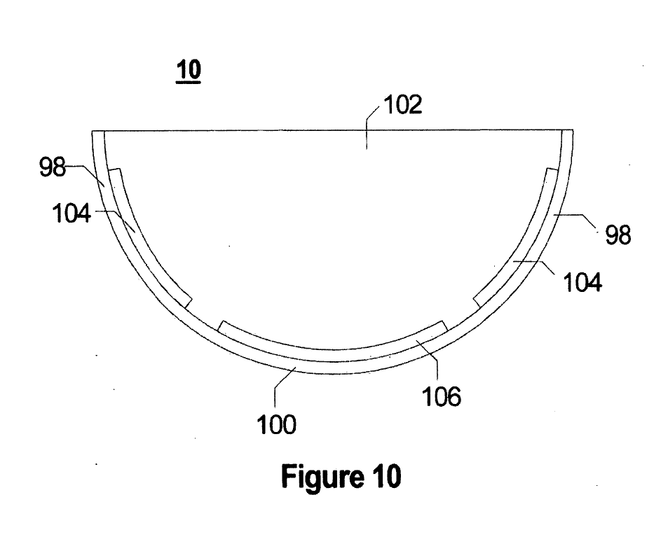

In yet a further aspect of the present invention, the aquatic tank 10 may have a cross-sectional shape of crescent shape, as represented in FIG. 10, having side portions 98, and a bottom-most portion 100, with a divider panel 102, shown arranged in a supported manner therewithin. The divider panel 102 has an arrangement of side openings 104 corresponding with the side portions 98 of the aquatic tank 10 represented here as of crescent shape, and with a bottom opening 106, shown here corresponding to the bottom-most portion 100 of the aquatic tank 10.

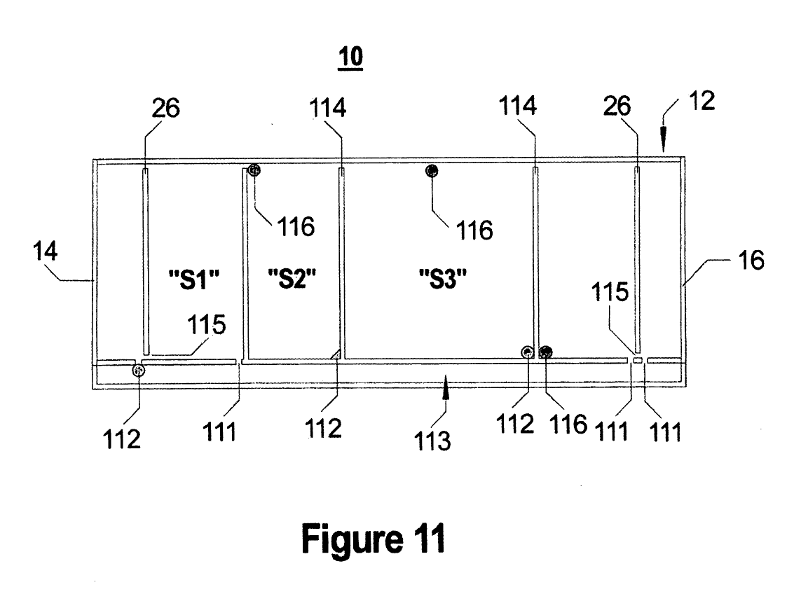

FIG. 11 illustrates still yet a further embodiment of the present invention the aquatic tank 10 that substitutes the bottom gap or adds to the cleansing ability of the bottom gap 115 with a water withdrawal mechanism such as floor holes/slots 111, a conduit 112 or other type of plenum 113 thereby removing water from the compartments, In this embodiment the divider panels can also be fixed 114 and/or without a lower gap 115 such as may be used in large or commercial scale aquatic tanks. The influx of water can be supplemented with additional inflows 116 at locations that help recreate/supplement the cleansing currents.

We claim:

1. A system for the sustained support and segregation of various species of aquatic life in a fluid containment tank, the tank having an upstream water feed end and a downstream water discharge end, the system comprising:
an arrangement of outer support and enclosure walls and a lowermost floor comprising the fluid containment tank;
at least one divider panel supported between the outer support and enclosure walls to divide the tank into at least two compartments, the divider panel having a pair of side edges and a lowermost edge in supported contact with the outer support and enclosure walls;
a gap between the lowermost edge of the at least one divider panel and the lowermost floor to permit a flow of water therebetween from the upstream end and the downstream end of the containment tank, while maintaining aquatic life within the at least two compartments segregated from one another.

2. The system as recited in claim 1, wherein the fluid containment tank is of rectilinear configuration.

3. The system as recited in claim 1, wherein the outer enclosure and support walls of the fluid containment tank are of curvilinear configuration.

4. The system as recited in claim 2, wherein the lowermost floor is of stepped configuration.

5. The system as recited in claim 2, wherein the lowermost floor is of sloped configuration.

6. The system as recited in claim 1, including a filter arrangement at the upstream water feed end of the containment tank for treating and filtering water and establishing a current through the system.

7. The system as recited in claim 6, including a filter arrangement at the downstream water discharge end of the containment tank for filtering water as the water leaves the system.

8. The system as recited in claim 7, including a fluid recycling arrangement for recycling water from the downstream end of the containment tank into the upstream end of the containment tank.

9. The system as recited in claim 1, wherein the divider panels have an opening extending between their side edges and the outer support and enclosure walls, to permit a narrow flow of water to flow from an upstream compartment to a downstream compartment along the sidewalls of the enclosure and support walls.

10. The system as recited in claim 4, wherein the divider panels are of varying height-wise dimensions along the downstream direction.

11. A method of safely maintaining, supporting and segregating various species of aquatic life in a common aquatic containment tank, the aquatic tank having an upstream treated water feed end and a downstream water discharge end, comprising:
arranging an outer side support wall portion and a lowermost floor portion to comprise the fluid containment tank;
placing at least one divider panel supported across the outer support wall portion so as to divide the tank into at least two compartments, the at least one divider panel having a pair of side portions and a lowermost portion in supported contact with the outer support wall portion;
forming an opening between the lowermost portion of the at least one divider panel and the lowermost floor portion, to permit a flow of water therebetween from the upstream end towards the downstream end of the aquatic containment tank, while maintaining aquatic life within the at least two compartments segregated from one another so that debris may flow under the at least one divider panel to be collected at the downstream end of the system.

12. The method as recited in claim 11, including:
filtering the water as the water is removed from the downstream end of the containment tank.

13. The method as recited in claim 11, including:
recycling the water as the water is removed from the downstream end of the containment tank up to the upstream end of the containment tank.

14. The method as recited in claim 13, including:
filtering the water prior to the water being fed into the upstream end of the containment tank.

15. The method as recited in claim 11, wherein the aquatic containment tank is of non-rectilinear configuration.

16. A system of safely maintaining, supporting and segregating various species of aquatic life in a common aquatic containment tank, the aquatic tank having an upstream treated water feed end and a downstream water discharge end, the system comprising:
at least one divider panel having side portions and a lower portion, the divider panel arranged across the containment tank to divide the tank into at least two species segregatable compartments;
a pump facilitated filtration arrangement to withdraw water from a downstream end of the system and to recycle the water into the upstream end of the system, the pump facilitated filtration arrangement also creating a flow of current between the at least two compartments; and
at least one opening along the lower portion of the at least one divider panel to facilitate the flow of current and any debris from an upstream compartment to a downstream compartment.

17. The system as recited in claim 16, wherein the filtration system is arranged at both the upstream water feed end and at the downstream water discharge end of the containment tank.

18. The system as recited in claim 17, wherein the at least one divider panel is displacably adjustable within the containment tank.

19. The system as recited in claim 18, wherein the at least one divider panel has an opening along a side edge portion thereof.

20. The system as recited in claim 19, wherein the aquatic containment tank has a shape selected from the group comprised of: a rectilinear configuration, a curved configuration in a plan view, and a curved configuration in a cross-sectional view.
